(19) United States
(12) Patent Application Publication
(10) Pub. No.: US 2007/0143559 A1
(43) Pub. Date: Jun. 21, 2007

(54) Apparatus, system and method incorporating virtualization for data storage

(76) Inventor: Yuichi Yagawa, San Jose, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/311,489

(22) Filed: Dec. 20, 2005

(51) Int. Cl. G06F 12/00

(52) U.S. Cl. 711/170

(57) ABSTRACT

For long-term data preservation, a storage virtualization system contains a metadata extraction module, an indexing module, a search module, and a virtualization module. The system utilizes two types of virtual volumes: unmarked volumes and marked volumes. The metadata extraction module extracts metadata that describes the data stored in logical volumes located in external storage. The indexing module scans the data and creates an index, and the index and metadata are stored in a local storage. After metadata is extracted for all data in a volume, and all data in the volume are indexed, the virtual volume corresponding to that volume is marked and the volume is ready to be made inactive. The search module allows a user to search for desired data using the metadata and the index stored in the local storage instead having to access the external storage systems where the data is actually stored.

### BACKGROUND OF THE INVENTION

1. Field of the Invention

The present invention relates generally to a storage system, and, more particularly, to a storage system which incorporates virtualization to identify, index and efficiently manage data for long-term storage.

2. Description of the Related Art

Long-Term Data Storage

Generally speaking, many companies and enterprises are interested in data vaulting, warehousing, archiving, and other types of long-term data preservation. The motivations for long-term data preservation are mainly due to governmental regulatory requirements and similar requirements particular to a number of industries. Examples of some such government regulations that require long-term data preservation include SEC Rule 17a-4, HIPAA (The Health Insurance Portability and Accountability Act), and SOX (The Sarbanes Oxley Act). The data required to be preserved is sometimes referred to as “Fixed Content” or “Reference Information”, which means that the data cannot be changed after it is stored. This creates situations different from a standard database, wherein the data may be dynamically updated as it is changed. Further, data vaulting is sometimes considered to be a more secure form of data preservation than typical data archiving, wherein the data may be stored off-site in a secure location, such as at tape libraries or disk farms, which may include manned security, auxiliary power supplies, and the like.

One common requirement for data preservation is scalability in terms of capacity. Recently, the amount of data required to be archived in many applications has increased dramatically. Moreover, the data is required to be preserved for longer periods of time. Thus, users require a storage system that has a scalable capacity so as to be able to align the size of the storage system with the growth of data, as needed.

Also, data preservation solutions must be cost effective, in terms of both initial cost and total cost of ownership (TCO). Thus, the system must be relatively inexpensive to buy and also inexpensive to operate in terms of energy usage, upkeep, and the like. The preserved data does not usually create any business value because the preserving of data for long periods is mainly motivated by regulatory compliances. Therefore, users want an inexpensive solution.

Furthermore, as the capacity of a storage system becomes massive, it becomes more and more difficult for users to find desired data. Also, a great deal of time may be required to locate data within a storage system having a very large capacity. Additionally, if the data are saved in an inactive external storage system, or the network to the external storage system does not work well, it can be very difficult for users to locate the data. Thus, it is desirable for a data preservation system to provide the capability to find data easily, quickly and accurately.

Related Power Management Solutions

Historically, large tape libraries have been used for storing large amounts of data. These tape libraries typically use remotely-controlled robotics for loading and unloading tapes to and from tape readers. However, recently, as the cost of hard disk drives has decreased, it has become more common to use large storage arrays for mass storage due to the higher performance of disk systems over tape libraries with respect to access times and throughput. One such disk system arrangement uses a large capacity storage system in which a portion of the disks are idle at any one time, which is referred to as a massive array of idle disks, or MAID. This system is proposed in the following paper: Colarelli, Dennis, et al., “The Case for Massive Arrays of Idle Disks (MAID)”, Usenix Conference on File and Storage Technologies (FAST), January 2002, Monterey, Calif. In the MAID system proposed by Colarelli et al., a large portion of the drives (passive drives) are inactive and a smaller number of the drives (active drives) are used as cache disks. The passive disks remain in a standby mode until a read request misses in the cache or the write log for a specific drive becomes too large. In another variation, there are no cache disks, all requests are directed to the passive disks, and those drives receiving a request become active until their inactivity time limit is reached. The proposed MAID system enables reduced power consumption and increased response time.

Other examples of power management for storage systems are disclosed in the following published patent applications: US 20040054939, to Guha et al., entitled “Method and Apparatus for Power-Efficient High-Capacity Scalable Storage System”, and US 20050055601, to Wilson et al., entitled “Data Storage System”, the disclosures of which are hereby incorporated by reference in their entireties.

Virtualization

Recently virtualization has become a more common technology utilized in the storage industry. The definition of virtualization, as propagated by SNIA (Storage Networking Industry Association), is the act of integrating one or more (back end) services or functions with additional (front end) functionality for the purpose of providing useful abstractions. Typically virtualization hides some of the back end complexity, or adds or integrates new functionality with existing back end services. Examples of virtualization are the aggregation of multiple instances of a service into one virtualized service, or to add security to an otherwise insecure service. Virtualization can be nested or applied to multiple layers of a system. (See, e.g., www.snia.org/education/dictionary/v/.)

A storage virtualization system is a storage system or a storage-related system, such as a switch, which realizes this technology. Examples of storage systems that incorporate some form of virtualization include Hitachi TagmaStore™ USP (Universal Storage Platform) and Hitachi TagmaStore™ NSC (Network Storage Controller), whose virtualization function is called the “Universal Volume Manager”, IBM SVC (SAN Volume Controller), EMC Invista™, and CISCO MDS. It should be noted that some storage virtualization systems, such as Hitachi USP, contain physical disks as well as virtual volumes. Prior art storage systems related to the present invention include U.S. Pat. No. 6,098,129, to Fukuzawa et al., entitled “Communications System/Method from Host having Variable-Length Format to Variable-Length Format First I/O Subsystem or Fixed-Length Format Second I/O Subsystem Using Table for Subsystem Determination”; published US Patent Application No. US 20030221077, to Ohno et al., entitled “Method for Controlling Storage System, and Storage Control Apparatus”; and published US Patent Application No. US 20040133718, to Kodama et al., entitled “Direct Access Storage System with Combined Block Interface and File Interface Access”, the disclosures of which are incorporated by reference herein in their entireties.

Data Storage Systems Incorporating Storage Virtualization

A data storage system incorporating storage virtualization (or a storage virtualization system for long-term data preservation) can provide solutions to the problems discussed above. A storage virtualization system can expand capacity to include external storage systems, so the issue of scalability of capacity can be solved. For example, Hitachi's TagmaStore USP has a functionality called Universal Volume Manager (UVM) which virtualizes up to 32 PB of external storage (1 Petabyte=one million billion characters of information). On the other hand, there is no commercial storage system which can scale up to 32 PB as a single system. Also, a storage virtualization system can virtualize existing storage systems or cost effective storage systems, such as SATA (Serial ATA)-based storage systems, and help users to eliminate additional investment on purchasing new storage systems for long-term data storage and vaulting.

Additionally, if external storage systems have the capability of becoming inactive, such as being powered down, put on standby, or the like, then the overall system can save power consumption and reduce TCO. Also, it would be preferred if the network between the data vaulting system and the external storage systems may be constructed with lower reliability as a method of further reducing costs. For example, it would be advantageous if an ordinary LAN (Local Area Network), a WAN (Wide Area Network) or even a wireless (WiFi) network were used, rather than a more expensive specialized storage network, such as a FibreChannel (FC) network. Accordingly, a system to provide a solution to the above-mentioned problems also desirably would be robust despite the type and reliability of the network used, as well as despite the type and reliability of the external storage systems used.

### BRIEF SUMMARY OF THE INVENTION

Under a first aspect, the present invention includes a storage virtualization system that contains a metadata extraction module, an indexing module, and a search module. The storage virtualization system extracts metadata from data to be preserved, and creates an index for the data. The system stores the extracted metadata and the created index in a local storage.

Under an additional aspect, the system includes two types of virtual volumes: unmarked volumes and marked volumes. The unmarked volumes are not yet ready to be put off-line on standby, made inactive, turned off, or subject to any other cost effective treatment of the volumes, whereas the marked volumes are ready for such treatment.

Under yet another aspect, the metadata extraction module extracts metadata which describes the data stored in the actual logical volumes. The metadata thus extracted is stored in the local storage.

Under yet another aspect, the indexing module scans the data and creates an index for use in future searches of the data in the virtualized system, and the index thus created is also stored in the local storage.

After the metadata is extracted from all data in a volume, and also after all data in the volume has been indexed, the virtual volume is marked, so that the logical volume mapped to the virtual volume becomes ready to be put on standby, or otherwise made inactive. When a virtual volume is marked, a message or command may be sent to the external storage system having the logical volume that is mapped by the marked virtual volume, indicating that the corresponding logical volume may be made inactive.

Under a further aspect, the search module allows the hosts to search appropriate data using the metadata and the index stored in the local storage instead of having to access the external storage systems to conduct the search. Also, the metadata can be used for other general purposes, such as providing information regarding the data to the hosts and users.

Because the logical volumes mapped to the marked virtual volumes can be taken off-line or otherwise made inactive, the system can save power and other management costs, and, as a result, TCO is reduced. Additionally, because the locally-stored metadata and index do not require users to make unnecessary accesses to the external storage systems, the data preservation system of the invention using storage virtualization becomes robust with respect to the status of the external storage systems and the back-end network. Also, because the locally-stored metadata and index are used to search data, instead searching the physical data stored in the external storage systems, which may sometimes be inactive, finding the location of desired data becomes easy, quick and accurate.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates a logical system architecture of a first embodiment of the invention.

FIG. 2 illustrates an example of a hardware configuration that may be used for realizing the storage virtualization system.

FIG. 3 illustrates an exemplary hardware configuration of an IP interface adapter for use with the invention.

FIG. 4 illustrates an exemplary software structure on a host or other client.

FIG. 5 illustrates an exemplary software structure on a server.

FIG. 6 illustrates an exemplary data structure of metadata used with the invention.

FIG. 7 illustrates an exemplary data structure of the index of the invention.

FIG. 8 illustrates a process for metadata extraction and indexing.

FIG. 9 illustrates a process for searching for data following implementation of the invention.

FIG. 10 illustrates an exemplary graphic user interface of the invention.

FIG. 11 illustrates a process for using the user interface of FIG. 10.

FIG. 12 illustrates a system architecture of a second embodiment of the invention.

FIG. 13 illustrates a hardware architecture of the second embodiment of the invention.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views.

System Architecture of the First Embodiment

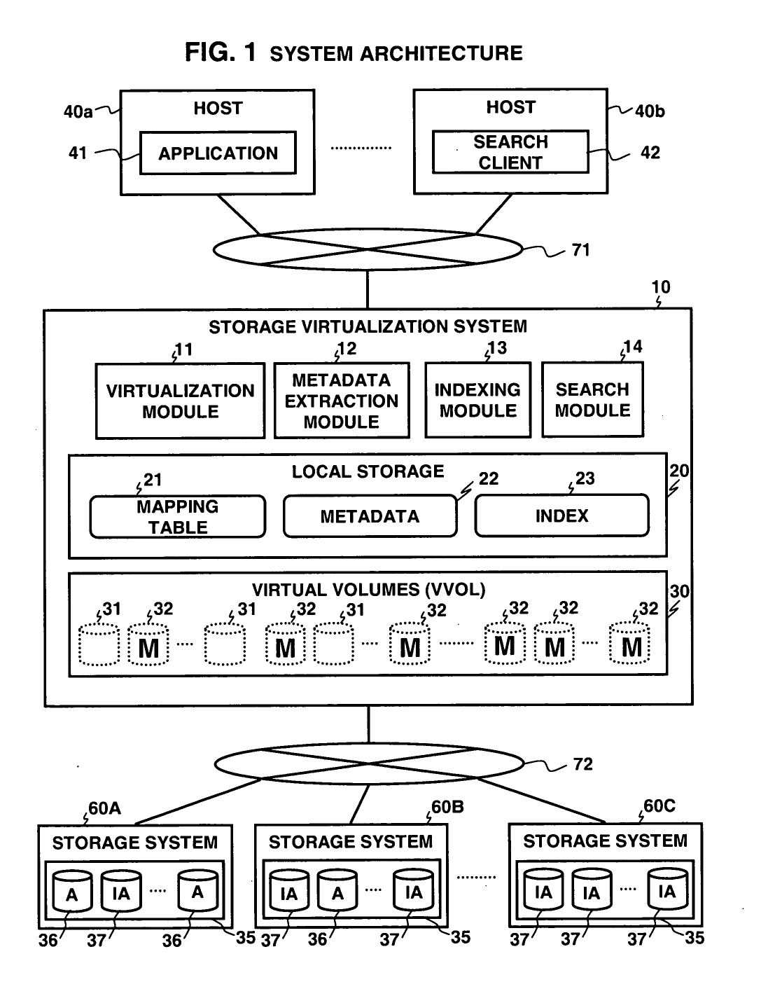

FIG. 1 shows logical system architecture of the first embodiment. The overall system consists of one or more hosts 40 (40a-40b in FIG. 1), a storage virtualization system 10 and a plurality of external storage systems 60 (60a-60c in FIG. 1) virtualized by the storage virtualization system 10. The hosts 40 and the storage virtualization system 10 are connected through a front-end storage network 71. Also, the storage virtualization system 10 and the external storage systems 60 are connected through a back-end storage network 72.

As is known, a storage virtualization system 10 may include a virtualization module 11 and mapping tables 21. The mapping tables 21 are stored in a local storage 20, which may be realized as local disk storage devices, local memory, both disks and memory, or other computer-readable medium or storage medium that is readily accessible. The storage virtualization system 10 of the invention contains virtual volumes 30, which are physically mapped to logical volumes 35 that actually store data on physical disks in the external storage systems 60, typically on a one-to-one basis, although other mapping schemes are also possible. This mapping information is defined in one or more mapping tables 21, and virtualization module 11 processes and directs I/O requests from the hosts 40 to appropriate storage systems 60 and volumes 35 by referring to mapping tables 21.

According to this embodiment of the invention, storage virtualization system 10 includes a metadata extraction module 12, an indexing module 13 and a search module 14. Also, the storage virtualization system 10 includes metadata 22 and an index 23 in the local storage 20. Further, there are two types of virtual volumes 30: unmarked virtual volumes 31 and marked virtual volumes 32. These virtual volumes 31, 32 map to logical volumes 36, 37, respectively. The unmarked virtual volumes 31 indicate that the logical volumes 36 mapped thereto are not yet ready to be made inactive, such as by having cost effective usages applied to these logical volumes 36. However, the logical volumes 37 mapped to the marked virtual volumes 32, may be made inactive, such as by detaching (putting on off-line), putting on standby, powering down either individual drives, arrays of drives, entire storage systems, or the like. This may be accomplished by the virtualization system 10 sending a message or command through network 72 to the appropriate external storage system 60 when a virtual volume 32 has been marked. If, for example, all logical volumes 35 in storage system 60c are mapped by virtual volumes 32 which have been marked, then these logical volumes 37 may be made inactive, and the storage system 60c may also be made inactive, powered down, or the like.

On the other hand, as for example, in the case of storage system 60a, if some of the logical volumes in the storage system are inactive volumes 37 mapped by marked virtual volumes 32, and some are active volumes 36, mapped by virtual volumes 31, which have not yet been marked, then only the logical volumes 37 that are mapped by marked virtual volumes 32 might be made inactive, such as by putting on standby certain physical disks in the storage system that correspond to inactive logical volumes 37. Alternatively, of course, all volumes a storage system might remain active until all logical volumes 35 in the storage system are mapped by marked virtual volumes 32, at which point the entire storage system may be made inactive.

In another embodiment (not shown), the storage virtualization system 10 may include indexing module 13 with index 23 or metadata extraction module 12 with metadata 22, or both. Also, the system may include other modules, such as data classification, data protection, data repurposing, data versioning and data integration (not shown). These modules may make use of metadata 22 or index 23. Further, in some embodiments, search module 14 may be eliminated.

Metadata extraction module 12 extracts metadata 22 which describes the data stored in logical volumes 35, and the extracted metadata 22 is stored in local storage 20. Additionally, indexing module 13 scans the data stored in each logical volume 35, and creates an index 23 representing content of the scanned data for use in conducting future searches. Index 23 is also stored in the local storage 20. After metadata 22 is extracted from all data in a logical volume 35, and after all data in the volume is indexed, the volume 32 may be marked, and then the corresponding logical volume 37 is ready to be made inactive.

Furthermore, the local storage 20 may include external storages defined virtually or logically as local storage, as well as including storage that is physically embodied as internal or local storages. This is achieved by virtualization capability, and, in spite of existing outside of the virtualization system, the virtually or logically defined local storage may not become inactive (i.e., is always accessible) if it contains metadata and/or index data.

In yet another embodiment, mapping table 21, metadata 22 and index 23 may each exist in different local storages. For example, the metadata 22 and the index 23 may exist in the virtually defined local storage, while the mapping table 21 may be stored in the physically local storage.

The search module 14 enables the hosts 40 to search for appropriate data using the metadata 22 and the index 23 stored in the local storage 20 instead of having to access and search the external storage systems 60. Also, metadata 22 may be used for other general purposes besides searching, such as providing information regarding the data to the hosts and users. Examples are data classification, data protection, data repurposing, data versioning, data integration, and the like.

Because the logical volumes 37 corresponding to the marked volumes 32 can be made inactive, the external storage systems 60 can save power and other management costs, and as a result, TCO is reduced. Additionally, because searching of virtual volumes 30 can be conducted via the internally-stored metadata 22 and index 23, it is not necessary to conduct searches for data in the external storage systems. Thus, the invention avoids unnecessary access to the external storage systems 60, and the system becomes robust with respect to status and reliability of the external storage systems 60 and the back-end network 72, since access to the external storage systems is only necessary when the data is actually being retrieved. Also, because the internally stored metadata 22 and index 23 are used to search data, instead of searching the physical data stored in the external storage systems 60, which may sometimes be inactive, finding appropriate data becomes easy, quick and more accurate.

The marking of a virtual volume 32 may be realized as a flag in the mapping table 21 or in any other virtual volume management information. The storage virtualization system may make the marked virtual volumes 32 inactive, which means that the virtual volumes are not attached to real external storages and volumes anymore. The system also may make off-line virtual volumes online again. This capability allows the system to use limited resources like LUNs and Paths efficiently. Also, the storage virtualization system may make external storages or volumes, to which the marked volume is mapped, inactive (idle) and, as necessary, make the inactive external storages or volumes active again. This is convenient for reducing power consumption in the case of long-term data preservation. This may be accomplished by sending a message to the external storage systems 60 to indicate that a logical volume may be made inactive. The message may provide notice to the external storage system that a particular logical volume may be made inactive, or may be in the form of a command that causes the external storage system to make inactive a particular logical volume. Further, as discussed above, the message may be a notice or command that causes an entire external storage system to become inactive if all of the logical volumes 35 in that storage system are mapped by marked virtual volumes 32.

Additionally, within an overall system, the number storage virtualization systems 10 may be more than one. However, if these plural storage virtualization systems are required to work together, such as for finding some particular data together, then they must be able to communicate with each other for sharing metadata 22 and indexes 23 as a single resource.

As a further example, one host, such as host 40a, may contain an application 41, which issues conventional I/O requests, such as writing and reading data. While, on the other hand, another host, such as host 40b, might contain a search client 42, which communicates with the search module 14. Applications that may include the search client 42 could include those that archive software and backup software, as well as file searching software. The number of the hosts 40 is not limited to two, and may extend to a very large number, dependent upon the network and interface type in use.

Additionally, the external storage systems 60 are the locations at which the data is actually stored. In order to reduce power consumption, some of the external storage systems 60 may become inactive or idle. Alternatively, only some of the physical disks in the storage systems 60 might be made inactive. Various methods for causing storage systems or portions thereof to become inactive are well known, as described in the prior art cited above, and these methods are dependent on specific implementations of the invention. Of course, the number of the external storage systems 60 is not limited to three, but may also extend to a very large number, depending upon the interfaces and network types used.

The front-end network 71 and the back-end network 72 are logically different, as represented in FIG. 1, but may share the same physical network in actuality. Examples of possible suitable network types include FC (FibreChannel) network and IP (Internet Protocol) network. In order to achieve cost savings, the back-end network 72 may constructed using a less expensive and correspondingly less reliable technology that does not provide as high performance as the front end network 71. For example, the back-end network 72 may be a wireless network or dial-up telephone line, while the front-end network might be an FC or SCSI network.

Hardware Architecture

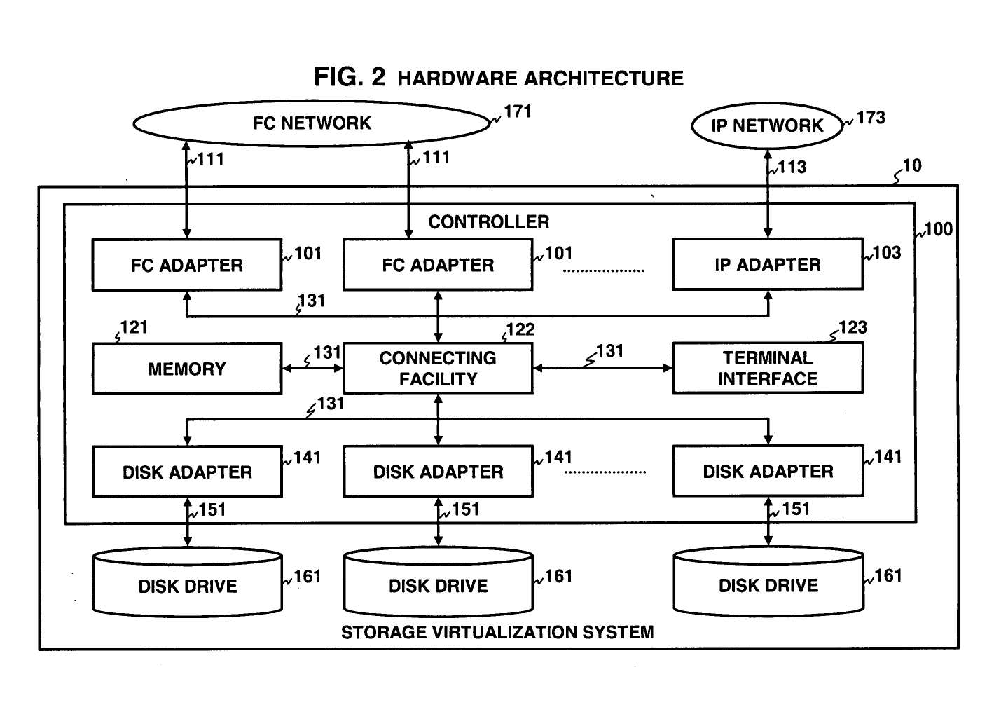

FIG. 2 illustrates an exemplary hardware architecture for realizing the storage virtualization system 10 of the invention. The storage virtualization system 10 consists of a storage controller 100 and internal disk drives 161. Data from the hosts are stored in either the internal disk drives 161 or the external storage systems 60 (not shown in FIG. 2). Further, the number of the disk drives 161 is not limited to the three illustrated and can be zero. For example, in the case that the number of internal disk drives is zero, data are stored in virtualized external storages or in-system memories.

The storage controller 100 consists of I/O channel adapters 101 and 103, memory 121, terminal interface 123, disk adapters 141, and connecting facility 122. I/O channel adapters 101, 103 are illustrated as FC adapters 101 and IP adapter 103, but could also be any other types of known network adapters, depending on the network types to be used with the invention. Each component is connected to each other through internal networks 131 and the connecting facility 122. Examples of the networks 131 are FC Network, PCI, InfiniBand, and the like.

The terminal interface 123 works as an interface to an external controller, such as a management terminal (not shown), which may control the storage controller 100, and send commands and receive data through the terminal interface 123. The disk adapters 141 work as interfaces to disk drives 161 via FC cable, SCSI cable, or any other disk I/O cables 151. Each adapter contains a processor to manage I/O requests. The number of the disk adapters 141 is also not limited to three.

In this embodiment, the channel adapters are prepared for any I/O protocols that the storage virtualization system 10 supports. In particular, there are FC adapters 101 and IP adapter 103. The FC adapters 101 communicate with hosts through FC cables 111 and an FC network 171. Also, the IP adapter 103 communicates with hosts through an Ethernet cable 113 and an IP network 172. There may be other protocols and adapters implemented in the storage virtualization system 10, with the foregoing being merely possible examples. The number of the FC adapters is not limited to two, and also the number of IP adapters is not limited to one.

Generally, the I/O adapters 101, 103 and the disk adapters 141 contain processors to process commands and I/Os. The virtualization module 11, the metadata extraction module 12, the indexing module 13 and the search module 14 may be realized as one or more software programs stored on local storage 20 and executed on the processors of the I/O adapters 101, 103 and disk adapters 141. Alternatively, controller 100 may be provided with a main processor (not shown) for executing the software embodying virtualization module 11, metadata extraction module 12, indexing module 13 and search module 14. Also, the local storage 20 may be realized as the memory 121, the disk drives 161 or other computer readable memories, disks, or storage mediums, such as on the adapters 101, 103, 141, within the storage virtualization system 10.

In an alternative variation, the virtualization module 11, the metadata extraction module 12, the indexing module 13 and the search module 14 may be realized as a software program executed outside of the controller 100, such as in a specific virtualization appliance (not shown). In this case, the system contains the virtualization appliance, and the controller 100 communicates with the appliance through its control interface, such as the terminal interface 123. The metadata 22 and the index 23 may reside on either the internal disks 161 or any local storage area (memory or disk) in the virtualization appliance.

In yet another alternative variation, the storage virtualization system 10 does not contain any disk drives 161, and the storage controller 10 does not contain any disk adapters 141. In this case, data from the hosts is all stored in the external storage systems 60, and the local storage may be realized as the memory 121 or external storage logically defined as local storage.

IP Adapter

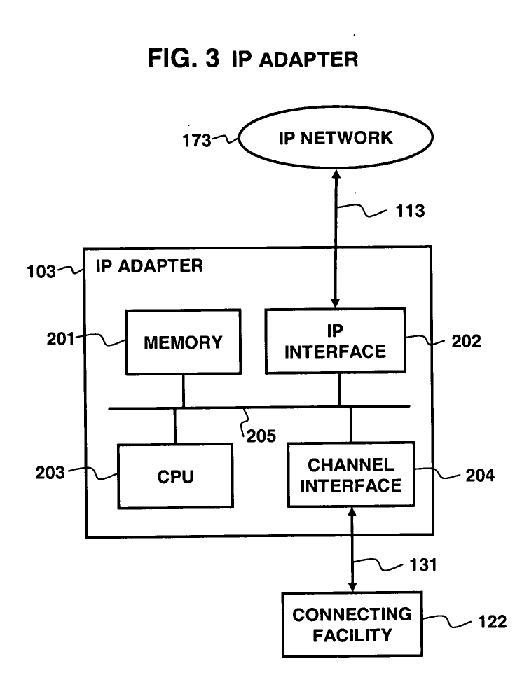

FIG. 3 shows an example hardware configuration of IP interface adapter 103. The adapter 103 consists of a processor or CPU 203, a memory 201, an IP interface 202, a channel interface 204, among the components used in the invention. Each component is connected through an internal bus network 205, such as PCI. A network connection 113 may be an Ethernet connection, wireless connection, or any other IP network type.

The channel interface 204 communicates with other components on the controller 100 through the connecting facility 122 via internal connection 131. Those components are managed by an operating system (not shown) running on CPU 203. The adapter 103 may be implemented using general purpose components. For example, the CPU 203 may be Intel-based, and the operating system may be Linux-based. A hardware configuration of the FC adapter 101 is basically similar to that of the IP adapter illustrated in FIG. 3, except that the FC adapter 101 contains a CPU adapted to execute FC processes and other commands.

Software Architecture

The present embodiment supposes that the storage virtualization system 10 provides file services, such as NFS or CIFS protocol based services, to the hosts. Correlating FIG. 1 with FIG. 2, the front-end network 71 and the back-end network 72 may both be realized by the IP network 173. Alternatively, front-end network 71 may be realized by IP network 173 and back-end network 72 may be realized by FC network 171, or vice versa, or still alternatively, both the front-end network 71 and the back-end network 72 may be realized by the FC network 171. As stated above, it is preferable to use a less expensive network type for the back-end network in the present invention when constructing a new system, but existing network types can also be used.

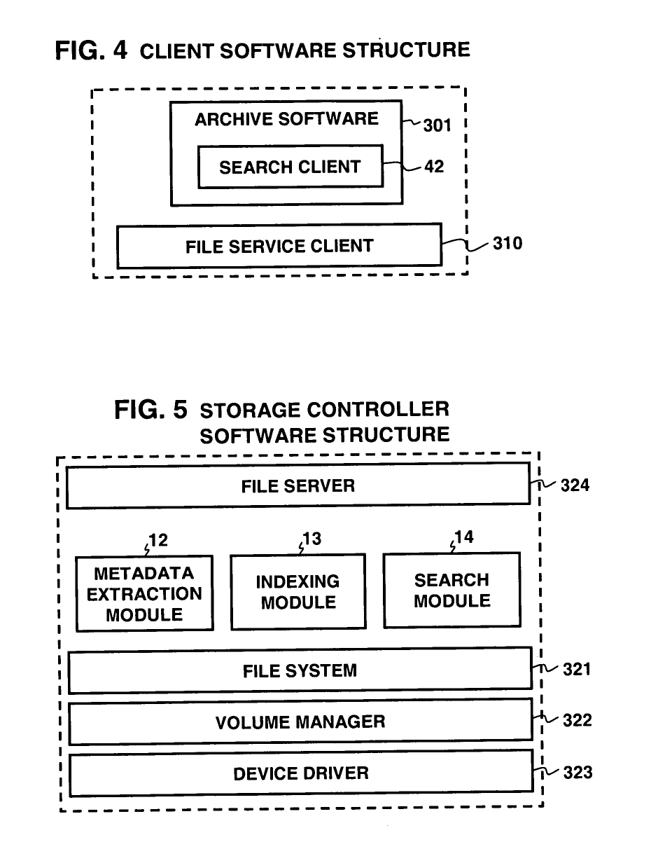

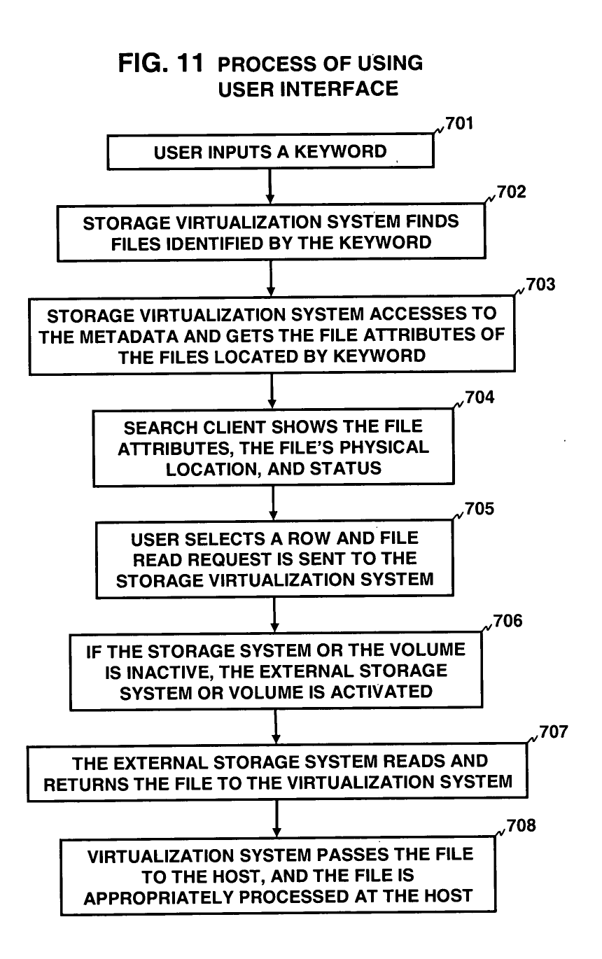

FIG. 4 illustrates the software architecture on the hosts 40, while FIG. 5 illustrates the software architecture on the storage controller 10, such as on the IP adapter 103 or on an appliance (such as gateway system 1010, which will be described in more detail below with reference to FIG. 11). File service client 310 on the hosts communicates with the file server software 324 on the controller, and receives any file-related services. Modules 12, 13, and 14 may be loaded in memory 201 on IP adapter 103, or may be in other local storage areas, as described above. Search client 42 and any other clients (not shown) corresponding to the modules 12, 13 and 14 may be implemented in any software program, such as archive software 301, backup software, and the like. Regarding the general implementation of storage virtualization including the virtualization module 11 and the mapping table 21, please see the prior art discussed above.

Software architecture running on top of the operating system of the IP adapter 103 or the appliance is illustrated in FIG. 5. The metadata extraction module 12, the indexing module 13, and the search module 14 are implemented as software programs executed by the IP adapter 103 or the appliance. Device driver 323, volume manager 322 and file system 321 allow those software programs to access any files stored in virtual volumes of the external storage systems as well as internal volumes. Device driver 323, volume manager 322 and file system 321 are software components that manage the relation or mapping between volumes and file systems. In order to extract metadata and index, these software components mount or un-mount appropriate volumes and allow the modules 12-14 to access to file systems. File server program 324 processes protocols like NFS (Network File System) and CIFS (Common Internet File System), and provides file services, including services provided by those programs, to the hosts.

Data Structures

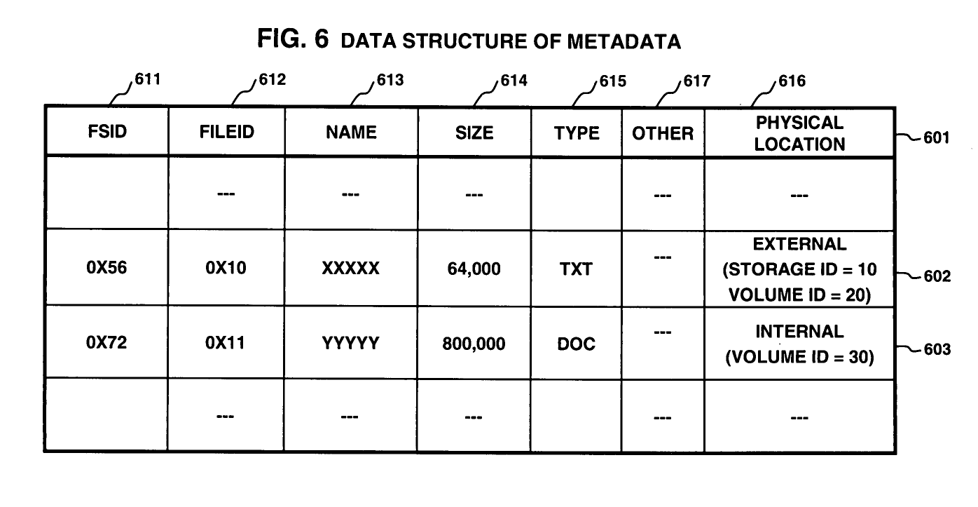

FIG. 6 shows an example data structure of metadata 22. According to one embodiment of the present invention, the metadata in columns 611-615, but not column 616, are extracted from file attributes in file systems. The metadata is as follows:

FSID: File System Identification 611;

FILEID: File Identification in the File System 612-FSID and FILEID together can be used to identify a single file in the system;

NAME: file name 613;

SIZE: file size 614;

TYPE: file type 615, such as text file, documentation file, etc.; and

OTHER: other attributes 617 can also be extracted from the data in the logical volumes 35.

Also, in another embodiment, user defining file attributes such as extended attributes in a file system may be extracted. For example, BSD (Berkeley Software Distribution) provides the “xattr” family of functions to manage the extended attributes in the file system. As is known in the art, extended attributes extend the basic attributes associated with files and directories in the file system. For example, in the xattr family of functions, the extended attributes may be stored as name:data pairs associated with file system objects (files, directories, symlinks, etc). (See, e.g., www.bsd.org/.) Other types of extended attributes may also be extracted.

Additionally, metadata data structure column 616 provides the physical location of the data. The process flow for extracting and using the metadata will be explained in more detail below. In FIG. 6, within physical location column 616, “External” means that the data is actually stored in one or more of the external storage systems 60, while “Internal” means that the data is actually stored in one or more of the internal disk drives 161. If the file is moved from one location to another location, or if the file attributes are modified, the metadata should be updated. Because the data is fixed and stored in a long-term data preservation scheme, modifying and moving of the data occurs seldom. Therefore, updating metadata usually would not require severe transaction management, such as lock management.

In yet another embodiment, the physical location is investigated on demand. For example, when metadata for a file is accessed, the system identifies the file's physical location by accessing any location tables including the mapping table 21 with key identifiers, such as FSID and FILEID. By this, the physical location of the file can be specified by use of the mapping table 21.

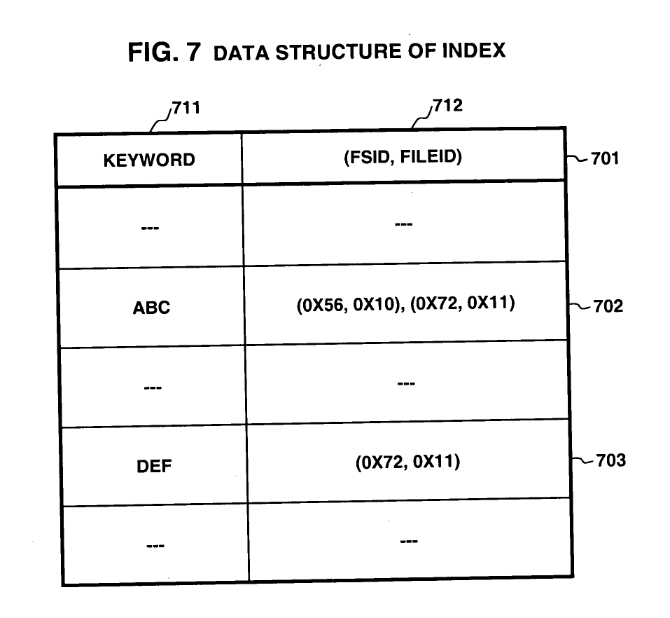

FIG. 7 shows an example data structure of index 23. The example shows a typical index, but the structure may be more complex in the real world use, such as in the manner provided by GoogleO and similar search engines.

Keywords 711 are extracted from files.

(FSID, FILEID) indicates files that contain a keyword.

For example, a keyword “ABC” is contained in files identified by (0x56, 0x10) and (0x72, 0x11), but a keyword “DEF” is contained in only a file identified by (0x72, 0x11). Data structures of index 23 may depend on file types used in a system, or other constraints. For example, a data structure of an index for music, image, or motion-picture-based files may be different from the example illustrated in FIG. 7.

Process Flow—Metadata Extraction and Indexing

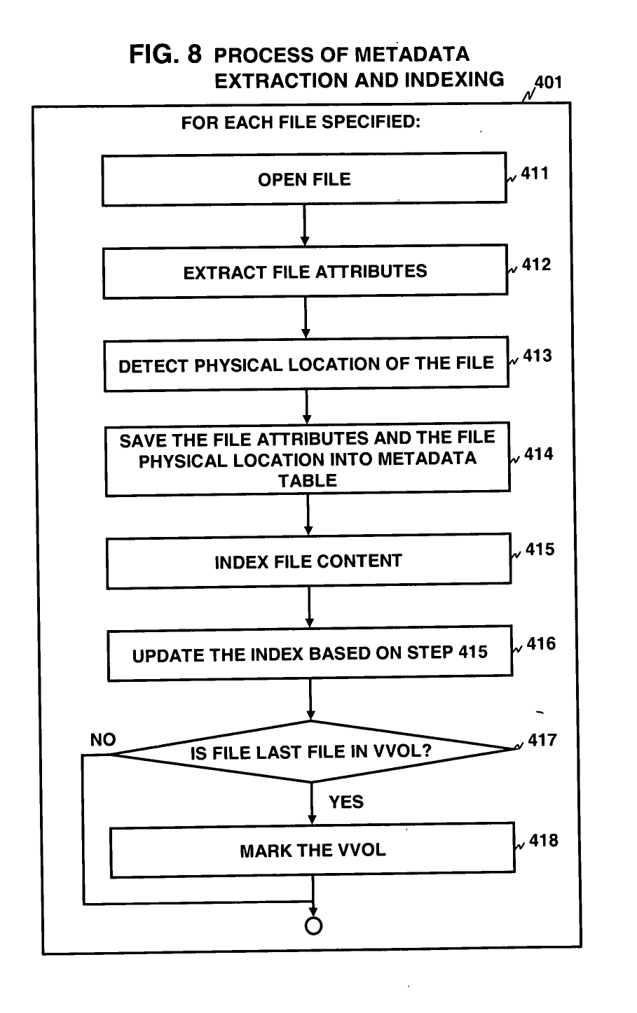

FIG. 8 shows an example process flow for metadata extraction and indexing. For example, archive software or backup software may specify those files as targets of archive or backup. For example, a virtual volume 30 may be specified for preparation for long-term storage, and the process may sequentially process each file in the specified virtual volume by extracting metadata from and indexing data in the logical volume corresponding to the specified virtual volume. Steps 411 through 416 are executed for each file specified by a user or a system.

Step 411: The process opens the specified file.

Step 412: The process extracts file attribute metadata from the file. For instance, standard file attributes 611-615 in the file system are extracted. Also, any other user-defined file attributes or any other attributes that describe the file may be extracted.

Step 413: The process detects the physical location 616 of the file. If the file is stored in an external storage system, it may difficult to identify the physical location because the external storage system is virtualized. Therefore, the process may access the mapping table 21 and determine the physical location in that manner.

Step 414: The file attributes and physical location are stored in the metadata 22 as illustrated in FIG. 6.

Step 415: The process indexes the file. The manner of indexing may be different among file types, and the actual indexing depends on each particular implementation of the invention. For example, commercial software or open source software can be utilized as the indexing module. In the case of the embodiments discussed above with respect to FIG. 7, the process may extract keywords from the file content.

Step 416: The process updates the index 23 based on the extracted keywords in step 415. In FIG. 7, FSID and FILEID will be added to each row identified by the keyword extracted from step 415.

Step 417 and 418: If the file is the last in the virtual volume (WOL), then the VVOL is marked. Otherwise, the process goes to the next file specified, such as the next sequential file in the virtual volume.

In another embodiment, metadata extraction and indexing may be performed in separate processes. In this case, the steps 417 and 418 are included in both processes and additionally ensure that metadata extraction and indexing have both been done before the virtual volume is marked.

In another embodiment, steps 417 and 418 may be executed separately from metadata extraction and indexing. For example, completion of metadata extraction and indexing may be checked for all data in each virtual volume specified.

Process Flow—Searching

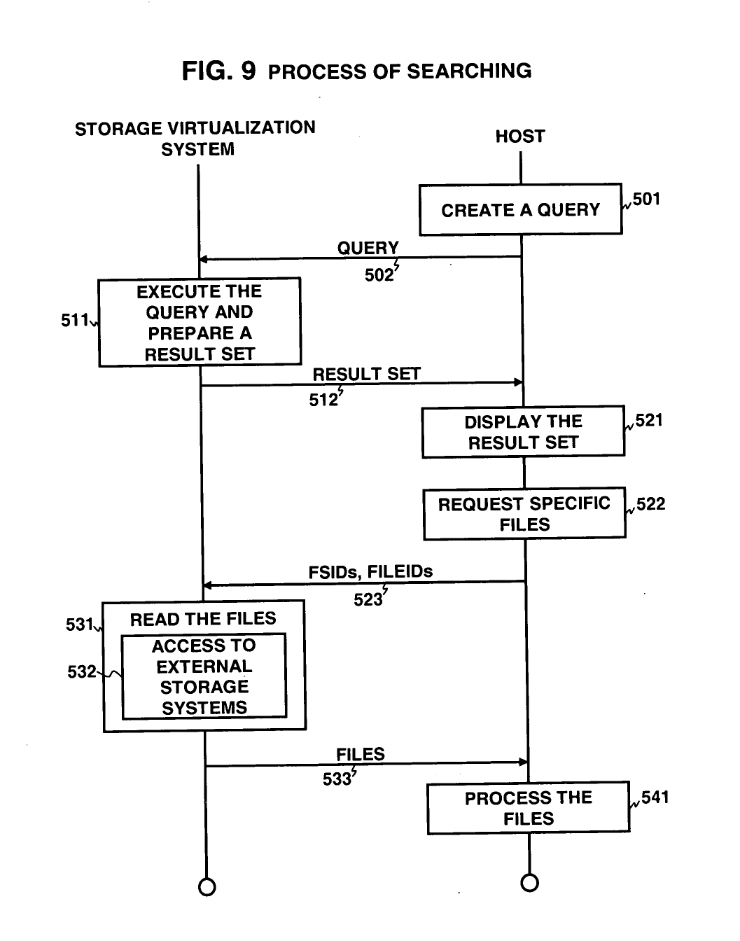

FIG. 9 illustrates an example process of searching for data, such as a file using the present invention. FIG. 9 also illustrates a protocol between the storage virtualization and the host.

Step 501: The host creates a query 502 and sends it to the storage virtualization system. For example, a user may input a keyword at the host.

Step 511: The storage virtualization system executes the query, prepare a result set 512 containing a list of files which matches the query and send the result set 512 to the host. For example, the storage virtualization system uses the keyword in the query to search the index, finds the keyword in the index, gets (FSID, FILEID) and gets the file attributes from the metadata specified by (FSID, FILEID). In another example, an attribute match search may be executed whereby the storage virtualization system searches the metadata attributes to match stored file attributes with a queried attribute.

Step 521: The host displays the result set to the user. For example, the file attributes obtained from the stored metadata may be communicated to and displayed by the host. Additionally, or alternatively, the physical location of the file may be communicated to and displayed on the host.

Step 522: One or more files are specified and requested to be accessed. For example, the user may specify the file or files on the display, and the specified (FSID, FILEID) may be sent in an access request 523 to the storage virtualization system. Alternatively, the file physical location may be sent in the access request.

Step 531: The storage virtualization system reads the files and, as step 533, sends them back to the host. If the file exists in an external storage system, the storage virtualization system accesses the external system as step 532. For example, if the (FSID, FILEID) access request 523 identifies a virtual volume, the mapping table 22 may be used to find the physical location of the file, and an access request is sent to appropriate external storage system if the file requested is stored externally. The specified external storage system or the specified logical volume is made active, if necessary, and the file or other specified data is retrieved from the specified logical volume. The external storage system or logical volume may then be made inactive again immediately or following a specified predetermined time period.

Step 541: The files are processed by an appropriate program or otherwise utilized by the host that made the request. For example, a reviewing program may display the accessed files on the display of the host, etc. The file protocol may comply with an ordinary protocol, like NFS or CIFS.

Search Client User Interface

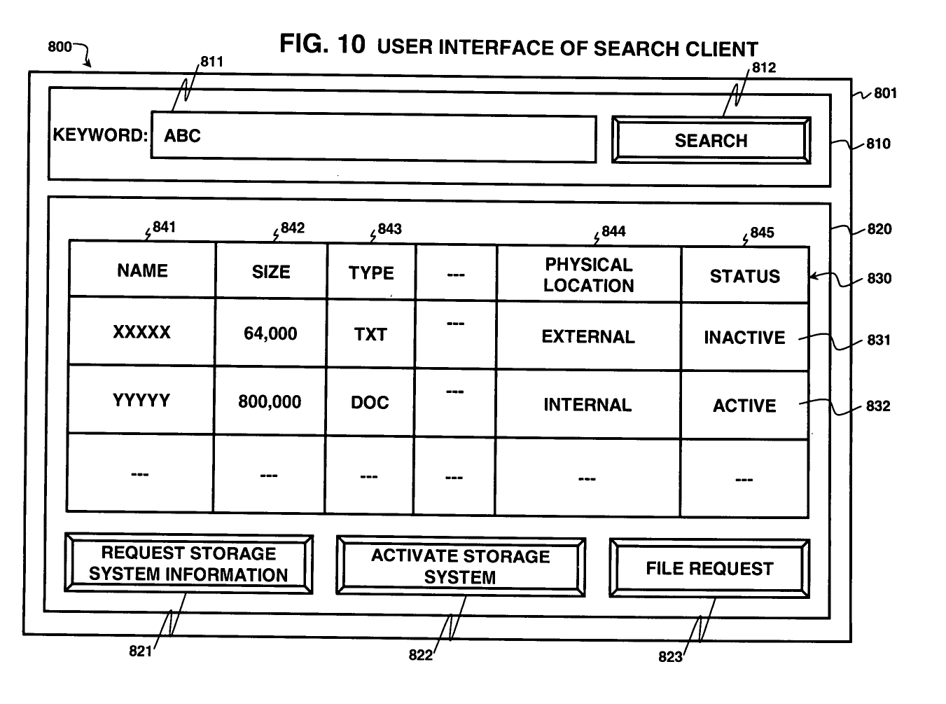

FIG. 10 shows an example user interface 800 of search client. A window 801 consists of a search request area 810 and a search result area 820. The search request area 810 consists of a keyword input area 811 and a search command button 812. A user inputs a keyword in the input area 811, pushes the search button 812, and then gets a result list 830. The search result area 820 consists of the result list 830 and command buttons 821-823. The list 830 contains information from the metadata such as name 841, size 842, type 843, and physical location 844, and may also include the status 845 of the logical volume, showing whether the logical volume is active or inactive.

User interface 800 may also contain additional status information of storage systems and logical volumes which physically store data. The status information may indicate whether the data itself can be accessed immediately. The status may be checked by the storage virtualization system before it returns the result set 512 discussed above. Or, a button 821 may request the latest information about the storage systems and volumes that contain listed data, including the status information. If the target storage system is inactive, the user may activate the storage system or volume by selecting the specific item in the list and pushing a button 822. How to activate the inactive storage system or volume depends on each implementation. For example, the storage virtualization system may send a specific message to the target external storage system and ask it to activate a specific volume.

To display data, a user specifies a file or other data in the list 830 and pushes a button 823 to request the data to be displayed. As illustrated in FIG. 11, the following is an example process for using the interface 800.

Step 701: A user inputs a keyword “ABC” and clicks on the button 810. The keyword becomes a query 502.

Step 702: The storage virtualization system finds files identified by the keyword as illustrated in FIGS. 7 and 9.

Step 703: The storage virtualization system accesses to the metadata and gets the file attributes of the files located by keyword. The status of the logical volumes may be indicated 845.

Step 704: The search client shows the file attributes, the file's physical location, and status.

Step 705: The user may select a row 831 and push the button 823. The file read request is sent to the storage virtualization system.

Step 706: If the storage system or the volume is inactive, the storage virtualization system may activate the external storage system or ask the system to activate the volume.

Step 707: Then the external storage system reads and returns the file to the virtualization system.

Step 708: The virtualization system passes the file to the host, and the file is appropriately processed at the host.

Without the metadata 22 and the index 23 stored in the local storage area 20, it would be necessary to access the external storages every time a request is made to find data. This is undesirable, because this requires the external storage systems to be active always. Thus, the virtualization system of the present invention provides an efficient and economical way to maintain long-term storage of large amounts of data.

### Second Embodiment

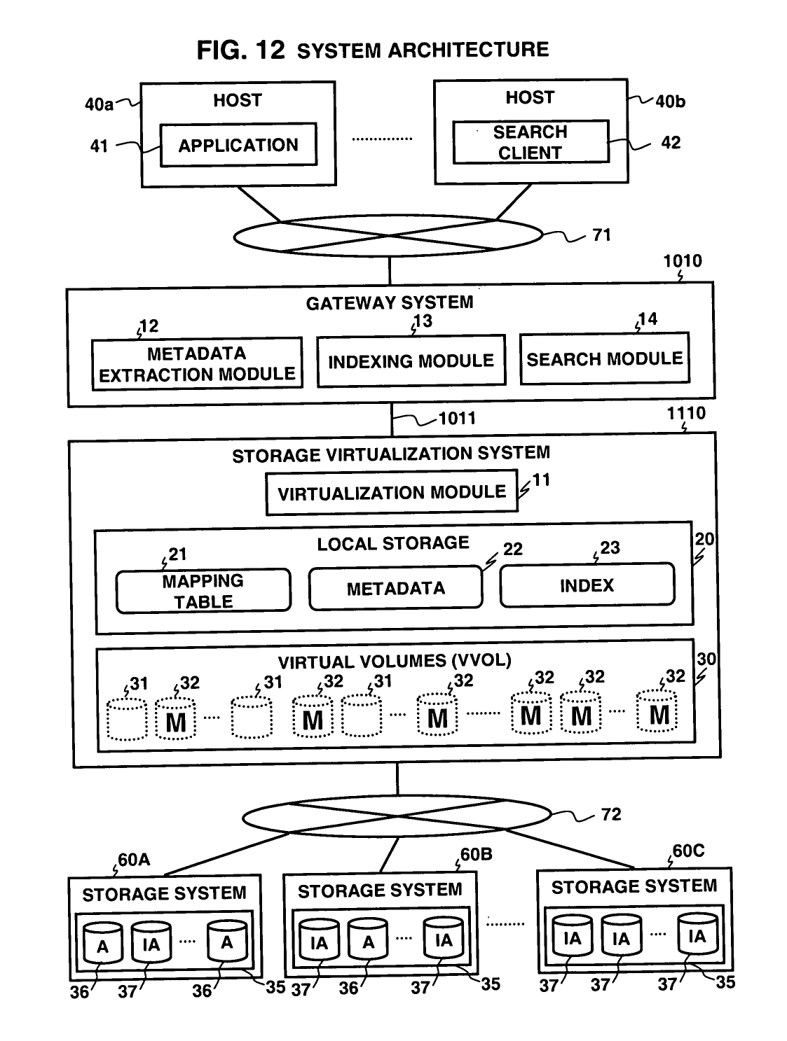

FIG. 12 illustrates a system architecture of a second embodiment of the invention. The metadata extraction module 12, the indexing module 13 and the search module 14 may be realized as one or more software programs stored and executed outside of the storage virtualization system, such as in a specific appliance or gateway system 1010.

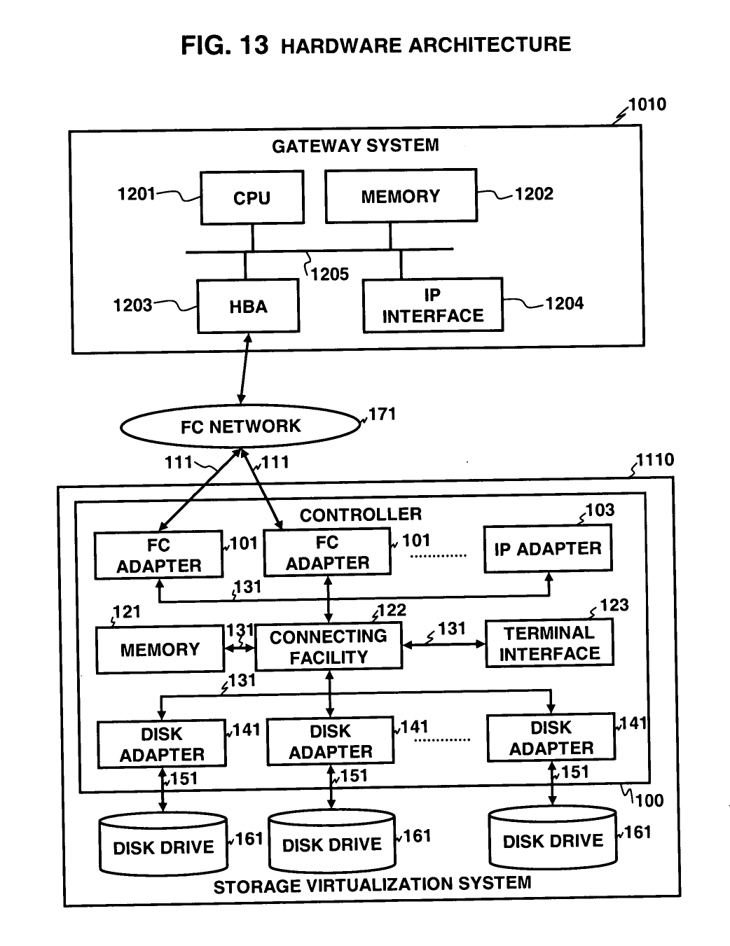

As illustrated in FIG. 13, the gateway system 1010 may be realized using the same hardware architecture as an ordinary host computer, such as a PC, or similar information processing device. Accordingly, gateway 1010, may include a CPU 1201, a memory 1202, a HBA (Host Bus Adapter) 1203, and an IP interface 1204 connected by an internal bus 1205. Metadata extraction module 12, indexing module 13 and search module 14 may be executed by CPU 1201 of gateway 1010, thereby reducing the load placed on controller 100 in the previously-discussed embodiment.

Gateway 1010 is able to connect to storage virtualization system 1110 through an FC connection 1011, which may physically be part of FC network 171. In another embodiment, the connection 1011 should be any networks like PCI, PCI Express and any others. Also, gateway 1010 may provide a file interface to the hosts 40, and may communicate with the hosts through IP network 71. Storage virtualization system 1110 is physically embodied by controller 100 and disk drives 161, as in the previous embodiment, and thus, further explanation of this portion of the second embodiment is not necessary. The storage virtualization system 1110 may have only an FC interface. Further, the metadata 22 and the index 23 may reside on either internal disks of gateway system 1010, internal disks of the storage virtualization system or external storage systems 60A-60C. The mapping table 21 needs to be in the storage virtualization system.

Gateway system 1010, the network connection 1011, and the storage virtualization system 1110 all together may be referred to as a complete storage virtualization system. In this case, the gateway system 1010 may decide which volume should be marked by ensuring that all metadata are extracted and all data are indexed in the volume. Then, gateway system 1010 sends a control command to the storage virtualization system 1110. The storage virtualization system 1110 marks those volumes, and then eventually may put off-line the virtual volumes and makes their corresponding real volumes inactive or idle. Search module 14 on gateway 1010 enables searching for particular files, or the like, as described above with respect to the first embodiment.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A system for storing data that incorporates a virtualization system, comprising:
a virtualization module for creating one or more virtual volumes mapping to one or more logical volumes storing data on an external storage system;
a metadata extraction module for extracting metadata from data in the one or more logical volumes as mapped by the one or more virtual volumes;
wherein the metadata enables searching of the data in the virtual volumes and determining a location of the data in said one or more logical volumes on the external storage system to which the virtual volumes are mapped.

2. The system of claim 1, further including:
an indexing module for indexing the data to create an index representing content of the data,
wherein the index as well as the metadata enables searching of the data in the virtual volumes and determining a location of the data in said one or more logical volumes on the external storage system to which the virtual volumes are mapped.

3. The system of claim 2, further including:
a graphic interface that simulates searching of said virtual volumes for desired data,
wherein, by searching said metadata and/or said index and using the results of the searching, a location of the desired data may be determined without searching said logical volumes to which the virtual volumes are mapped.

4. The system of claim 2, wherein:
when the virtualization system has completed metadata extraction and indexing of data in a logical volume mapped by a virtual volume, the virtual volume mapping thereto is marked as an indication that the logical volume may be made inactive.

5. The system of claim 4, wherein:
a logical volume that has been made inactive may be made active in response to an access request from the virtualization system, whereby a specified file or data may be accessed in said logical volume.

6. The system of claim 2, wherein:
the physical location of data is determined from the metadata as the metadata is extracted from the logical volumes.

7. The system of claim 2, further including:
a host in communication with the virtualization system, said host including a graphic user interface that enables a user to search the one or more virtual volumes in simulation of searching corresponding logical volumes by searching said metadata or said index, and
providing results based on the extracted metadata or index, the results including a physical location in the external storage system of data for which the user is searching.

8. The system of claim 2 further including:
a controller, said controller executing said virtualization module for creating the one or more virtual volumes mapping to the one or more logical volumes storing data on the external storage system; and
an information processing device separate from said controller for executing said metadata extraction module for extracting metadata from the data in the one or more logical volumes mapped by the one or more virtual volumes, and for executing said indexing module for indexing the data to create an index representing content of the data.

9. A virtualization system for a storage system including a virtualization module for mapping, on a one-to-one basis, a plurality of virtual volumes to a plurality of logical volumes located in external storage devices in communication with the virtualization system, said virtualization system comprising:
a metadata extraction module for extracting metadata from data stored in the logical volumes and storing the metadata in a local storage;
an indexing module for creating an index representing data stored in the logical volumes,
whereby, when extraction of metadata from a particular logical volume has been completed and the data stored on the particular logical volume has been indexed, a particular virtual volume mapping to the particular logical volume is marked whereby a communication is sent to the external storage system to indicate that the particular logical volume may be made inactive.

10. The virtualization system of claim 9, wherein:
the particular virtual volume mapping to the particular logical volume is marked to indicate that the particular logical volume may be made inactive.

11. The virtualization system of claim 9, wherein:
the location of data in the particular logical volume may be determined by searching the index and accessing the stored metadata while said particular logical volume is inactive.

12. The virtualization system of claim 9, further including a graphic user interface that displays whether desired data is located in a logical volume whose status is active or inactive.

13. The virtualization system of claim 10, wherein;
when all virtual volumes mapping to all corresponding logical volumes in a storage system have been marked, the storage system is made inactive.

14. The virtualization system of claim 9, wherein
the physical location of data is determined during extraction of metadata for the data by accessing a table that maps the particular virtual volume to the corresponding particular logical volume.

15. The virtualization system of claim 8, further including:
a host in communication with the virtualization system, said host including a graphic user interface that enables a user to search the virtual volumes as if searching corresponding logical volumes by searching said metadata and/or said index, and wherein the virtualization system provides results from the extracted metadata, said results including a physical location in the external storage system of data for which a user is searching.

16. The virtualization system of claim 9, wherein:
a controller is provided for said mapping, on a one-to-one basis, said plurality of virtual volumes to said plurality of logical volumes; and
an information processing device separate from the controller is provided for said extracting of metadata from data stored in the logical volumes and said creating of an index of data stored in the logical volumes.

17. A method for storing data, comprising:
providing a virtualization system including a virtualization module that creates virtual volumes that map to logical volumes in one or more external storage systems;
extracting metadata from data in the logical volumes mapped by corresponding virtual volumes;
adding, to an index, index information representing the data from which the metadata is extracted; and
upon completing of extracting the metadata and adding of index information from all data in a particular logical volume mapped by a particular virtual volume, sending a communication to the external storage device containing the particular logical volume indicating that the particular logical volume can be made inactive.

18. The method of claim 17, further including the step of:
making the external storage system inactive, when all logical volumes contained in that storage system have been indicated to be made inactive.

19. The method of claim 17, further including the step of:
providing a graphic user interface that simulates searching of a virtual volume by searching the index and returning results from the extracted metadata, said results including the physical location of desired data in the results returned from searching.

20. The method of claim 17, further including the step of:
marking the particular virtual volume upon completing of extracting the metadata and adding of index information from all data in the particular logical volume mapped by the particular virtual volume, said marking indicating that the particular logical volume mapped by the particular virtual can be made inactive.

21. The method of claim 17, further including the step of:
providing a controller and an appliance, wherein
said controller carries out said step of creating virtual volumes that map to logical volumes, and
said appliance carries out said steps of extracting metadata from data in the logical volumes mapped by corresponding virtual volumes and adding, to an index, index information representing the data from which the metadata is extracted.

22. A system for storing data, comprising:
a storage controller;
an information processing device separate from said controller and in communication therewith; and
one or more storages in communication with said controller and having one or more logical volumes, wherein
the controller creates virtual volumes that map to logical volumes in the one or more storages;
the information processing device extracts metadata from data in the one or more logical volumes mapped by corresponding virtual volumes, and adds, to an index, index information represent the data from which the metadata is extracted; and
the metadata and/or the index enables searching of the virtual volumes to determine the location of data in the one or more logical volumes.
